(19) United States
(12) Patent Application Publication
(10) Pub. No.: US 2011/0159223 A1
(43) Pub. Date: Jun. 30, 2011

(54) DIE-ATTACH FILM AND METHOD OF MANUFACTURING THE SAME

(76) Inventors: Baek Soung Park, Uiwang-si (KR); Min Kyu Hwang, Uiwang-si (KR); Ji Ho Kim, Uiwang-si (KR)

(21) Appl. No.: 12/977,664

(22) Filed: Dec. 23, 2010

(30) Foreign Application Priority Data
Dec. 24, 2009 (KR) 10-2009-0131248

(51) Int. Cl. B32B 7/12; B44C 1/17; B32B 37/06

(52) U.S. Cl. 428/41.5; 156/235; 156/299; 428/40.1; 428/345

(57) ABSTRACT

A die-attach film and a method of manufacturing the same, the method including providing a dicing film layer with the attach layer thereon, the dicing film layer being prepared from a photocurable adhesive composition and including an attach layer region overlapping the attach layer such that the attach layer blocks inflow of oxygen into the attach layer region, and a ring frame region, the ring frame region having an upper surface that is adjacent to the attach layer and is exposed to air or an oxygen atmosphere such that oxygen flows into the ring frame region; and irradiating UV light to a back side of the dicing film layer to induce photocuring of the attach layer region, the oxygen in the ring frame region acting as a radical scavenger and suppressing photocuring of the ring frame region.

### BACKGROUND

1. Field

Embodiments relate to a die-attach film and a method of manufacturing the same.

2. Description of the Related Art

In a semiconductor packaging process, a wafer having a semiconductor circuit formed thereon may be adhered to a die-attach film, e.g., a dicing die-bonding film, and may then be sawed into small semiconductor chips by sawing. The chips may then be lifted off of the die-attach film by a pick-up process. In this case, to separate a dicing film layer of the die-attach film from an attach layer adhered to the chips, UV exposure may be performed to reduce adhesion between the attach layer and the dicing film layer so as to allow the chips to be picked up. The picked-up chips with the attach layer adhered thereto may then be adhered to a package substrate or other semiconductor chips and subjected to an Epoxy Molding Compound (EMC) process, thereby providing a final semiconductor package.

### SUMMARY

Embodiments are directed to a die-attach film and a method of manufacturing the same.

The embodiments may be realized by providing a method of manufacturing a die-attach film including an attach layer for attaching to a wafer, the method including providing a dicing film layer with the attach layer thereon, the dicing film layer being prepared from a photocurable adhesive composition and including an attach layer region overlapping the attach layer such that the attach layer blocks inflow of oxygen into the attach layer region, and a ring frame region, the ring frame region having an upper surface that is adjacent to the attach layer and is exposed to air or an oxygen atmosphere such that oxygen flows into the ring frame region; and irradiating UV light to a back side of the dicing film layer to induce photocuring of the attach layer region, the oxygen in the ring frame region acting as a radical scavenger and suppressing photocuring of the ring frame region.

The method may further include adhering a cover layer to the attach layer; adhering a transparent handling film to the back side of the dicing film layer; and removing the cover layer to expose the upper surface of the ring frame region to the air or oxygen atmosphere and induce inflow of oxygen into the upper surface of the ring frame region of the dicing film.

The method may further include providing a light masking blade to the back side of the dicing film layer to shield the ring frame region from UV irradiation.

The embodiments may also be realized by providing a die-attach film manufactured by the method of an embodiment.

The embodiments may also be realized by providing a die-attach film including an attach layer for attaching to a wafer; and a dicing film layer under the attach layer, the dicing film layer being prepared from a photocurable adhesive composition and including an attach layer region, and a ring frame region, wherein the attach layer region overlaps the attach layer and has a reduced tackiness through photocuring relative to the ring frame region, and the ring frame region has an exposed upper surface adjacent to the attach layer and retains a higher tackiness than the attach layer region by avoiding the photocuring.

The ring frame region may retain about 60% or more of an initial tackiness of the dicing film layer and the attach layer region may be reduced in tackiness to about 20% or less of the initial tackiness of the dicing film layer.

The embodiments may also be realized by providing a die-attach film, including an attach layer for attaching to a wafer; a dicing film layer under the attach layer, the dicing film layer being prepared from a photocurable adhesive composition and including an exposed ring frame region for attaching to a ring frame; a cover layer adhered to the attach layer; and a transparent handling film adhered to a back side of the dicing film layer, the transparent handling film being capable of transmitting UV light irradiated for partial photocuring of the dicing film layer.

The ring frame region of the dicing film layer may retain higher tackiness relative to a region of the dicing film layer overlapping the attach layer upon UV exposure.

The cover layer may include a polyethylene terephthalate (PET) film layer.

The dicing film layer may be prepared from a photocurable adhesive composition cured by UV light.

The photocurable adhesive composition may include an acrylic adhesive binder, a photo-initiator, and a thermal curing agent.

The handling film may include a polyethylene terephthalate (PET) film, the PET film exhibiting a transmittance of at least about 80% with respect to the UV light.

### BRIEF DESCRIPTION OF THE DRAWINGS

The embodiments will become more apparent to those of ordinary skill in the art by describing in detail exemplary embodiments with reference to the attached drawings, in which:

FIGS. 1 to 5 illustrate a die-attach film and stages in a method of manufacturing the same according to an embodiment; and

FIGS. 6 and 7 illustrate Comparative Examples provided to explain the embodiments.

### DETAILED DESCRIPTION

Korean Patent Application No. 10-2009-0131248, filed on Dec. 24, 2009, in the Korean Intellectual Property Office, and entitled: “Non-Uv Type Die-Attach Film and Method of Manufacturing the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Embodiments provide a, e.g., non-UV type, die-attach film and a method of manufacturing the same, which can retain adhesive strength of a rim of a dicing film layer to which a ring frame will be attached, while lowering or reducing adhesion between an attach layer and the dicing film layer to provide peel strength for a chip pick-up process, whereby UV exposure for lowering the adhesion during or between sawing and pick up processes may be eliminated.

According to the embodiments, during a process of manufacturing a die-attach film, i.e., prior to the semiconductor packaging process, portions of a dicing film layer prepared from a UV-curable adhesive composition may be cured by UV exposure, such that adhesive strength of the dicing film layer may be lowered to provide peel strength for the chip pick-up process. The adhesive strength of the dicing film layer may be adjusted to provide a retention force for retaining a wafer during dicing and the peel strength during the pick-up process.

During manufacture of the die-attach film, UV curing of the dicing film layer may be performed after an attach layer (for attaching a wafer) is formed on the dicing film layer. The dicing film layer may include an attach layer region, a central region of the dicing film layer, corresponding to the attach layer. An upper surface of the attach layer region may thus be shielded by the attach layer. The dicing film layer may also include a ring frame region, a rim of the dicing film layer near or adjacent to the attach layer that may be exposed to the atmosphere, e.g., air, an oxygen atmosphere, or the like. UV exposure may be performed to irradiate UV light to the dicing film layer through a back side thereof.

In an implementation, an upper surface of the ring frame region of the dicing film layer near or adjacent to the attach layer may be exposed to the atmosphere so that oxygen may be introduced from the atmosphere into a portion of the dicing film layer corresponding to the ring frame region. On the other hand, the central region of the dicing film layer may be shielded from the atmosphere by the attach layer. Thus, inflow of oxygen to the central region of the dicing film layer may be shielded or prevented by the attach layer.

The oxygen introduced into the ring frame region may inhibit UV-induced curing. The oxygen may be primarily coupled to radicals generated in the dicing film layer by the UV light and may prevent the radicals from participating in the curing reaction. For example, the oxygen may act as a scavenger for the radicals.

As described above, the central region of the dicing film layer may be shielded from the atmosphere by the attach layer. Thus, the inflow of oxygen to the central region of the dicing film layer may be shielded or prevented by the attach layer, so that the central region of the dicing film layer may be cured by UV exposure and may undergo a comparative reduction in adhesive strength. On the other hand, the ring frame region of the dicing film layer may retain higher adhesive strength than other parts of the dicing film layer, e.g., the central region, due to obstruction or delay of UV-induced curing by the prior exposure of oxygen thereto.

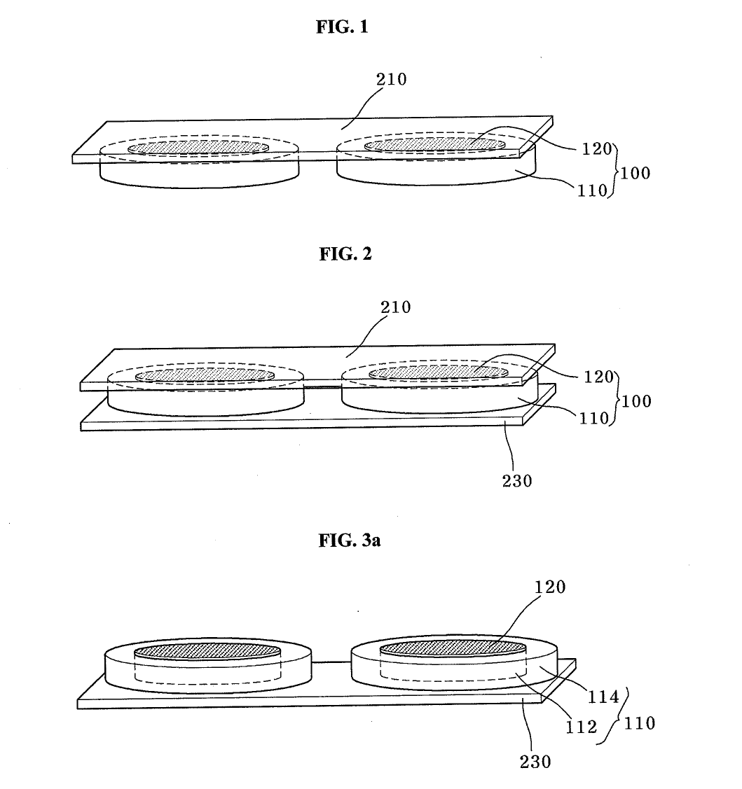

FIGS. 1-5 illustrate a die-attach film and stages in a method of manufacturing the same according to an embodiment. Referring to FIG. 1, a die-attach film 100 may include a dicing film layer 110, which may be a photocurable adhesive film, and an attach layer 120 for attaching chips transferred to the dicing film layer 110. The dicing film layer 110 may be formed from a photocurable adhesive composition, which may generate radicals and may undergo photocuring when exposed to UV light. The photocurable adhesive composition may be an adhesive composition used for typical dicing films or die-attach films. For example, the photocurable adhesive composition may include an acrylic adhesive binder, a photo-initiator, and a thermal curing agent.

The attach layer 120 may be provided to an upper surface of the dicing film layer 110. A first cover layer 210 may then be adhered to the attach layer 120, thereby completing primary preparation of the die-attach film 100. The first cover layer 210 may include, e.g., a polyethylene terephthalate (PET) film. An initial state of the die-attach film 100 may be the same as typical products in the field of semiconductor packages.

Referring to FIG. 2, a handling film 230, e.g., a PET film, may be adhered to a back side of the dicing film layer 110 of the die-attach film 100. The handling film 230 may exhibit a transmittance of at least about 80% in the UV wavelength range used for UV exposure. In an implementation, the handling film 230 may be formed of the same material as the first cover layer 210.

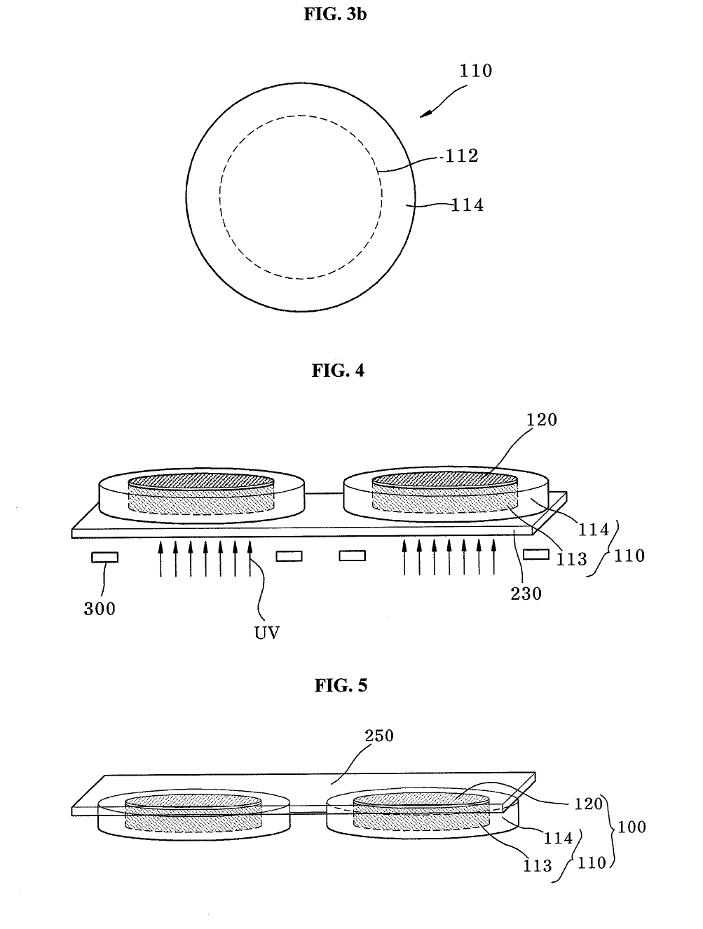

Referring to FIGS. 3a and 3b, the first cover layer 210 may be removed from the die-attach film to expose the attach layer 120 and a rim of the dicing film layer 110 near or adjacent to the attach layer 120. For example, the dicing film layer 110 may include an attach layer region 112, a central region of the dicing film layer 110, which corresponds to and is shielded from the atmosphere by the attach layer 120. The dicing film layer 110 may also include a ring frame region 114, the rim of the dicing film layer 110, which may be near or adjacent to the attach layer 120 and may be exposed to the atmosphere. The ring frame region 114 may include a region to which a ring frame will be adhered during the die-attach and pick-up processes.

Referring to FIG. 4, UV exposure may be performed by irradiating UV light to the dicing film layer 100 through a rear side of the handling film 230. During the UV exposure, the UV light may enter the dicing film layer 100 through the back side of the dicing film layer 100. As described above, the upper surface of the ring frame region 114 near the attach layer 120 may be exposed to the atmosphere so that oxygen may be introduced from the atmosphere into a portion of the dicing film layer 110 corresponding to the ring frame region 114. On the other hand, the attach layer region 112 (FIG. 3), e.g., the central region, of the dicing film layer 100 may be shielded from the atmosphere by the attach layer 120. Thus, inflow of oxygen to the attach layer region 112 of the dicing film layer 110 may be shielded or prevented by the attach layer 120. The oxygen introduced into the ring frame region 114 may inhibit UV induced curing. The oxygen may be primarily coupled to radicals generated in the dicing film layer 110 by the UV light and may prevent the radicals from participating in the curing reaction. For example, the oxygen may act as a radical scavenger. Consequently, the dicing film layer 110 in the ring frame region 114 may exhibit substantially the same adhesive strength as an initial adhesive strength of the die-attach film 100.

As described above, the attach layer region 112 of the dicing film layer 110 may be shielded from the atmosphere by the attach layer 120 (see FIG. 3). Thus, the inflow of oxygen to the attach layer region 112 of the dicing film layer 110 may be shielded or prevented by the attach layer 120, so that the attach layer region 112, e.g., the central region, of the dicing film layer 110 may be cured by the UV exposure and modified into a comparatively reduced adhesive strength region 113. For example, the reduced adhesive strength of the comparatively reduced adhesive strength region 113 may be adjusted so as to provide both peel strength for picking-up the sawed chips and retention force for retaining a wafer in an attached state to the attach layer 120 during the die-attach process. The adjustment of the adhesive strength of the comparatively reduced adhesive strength region 113 may be achieved by controlling UV exposure intensity or duration. On the other hand, the ring frame region 114 of the dicing film layer 110 may retain higher adhesive strength than other parts of the dicing film layer 110, e.g., the comparatively reduced adhesive strength region 113, due to obstruction or delay of UV-induced curing by the inflow of oxygen thereto. Consequently, the ring frame region 114 may retain a considerably strong binding force or attaching force to the ring frame during the die-attach process and the like, thereby effectively preventing failure, e.g., separation of the ring frame from the die-attach film.

During UV exposure, UV light may be irradiated towards the handling film 230. The UV exposure may be performed with the ring frame region 114 shielded by a mask, e.g., a light shielding blade 300. In this case, retention of the adhesive strength in the ring frame region 114 may be more reliably realized.

Referring to FIG. 5, a second cover layer 250 may be adhered to the attach layer 120. Also, the handling film 230 may be removed from the dicing film layer 110. As a result, the finally produced die-attach film 100 may include the dicing film layer 110 and the attach layer 120, in which the dicing film layer 110 includes the ring frame region 114 having relatively high adhesive strength and includes the comparatively reduced adhesive strength region 113 having lower adhesive strength, to allow the chips to be picked up.

The following Examples and experiments are given for illustrative purposes only and are not intended to limit the scope of this disclosure. Moreover, the Comparative Examples are set forth to highlight certain characteristics of certain embodiments and are not to be construed as either limiting the scope of the invention as exemplified in the Examples or as necessarily always being outside the scope of the invention in every respect

### Example 1

### Preparation of Die-Attach Film

As shown in FIGS. 1 to 5, in a prepared die-attach film, a comparatively reduced adhesive strength region 113 of a dicing film layer 110 exhibited reduced adhesive strength after UV exposure; and a ring frame region 114 of the dicing film layer 110 retained initial adhesive strength of the die-attach film 100 through oxygen based radical scavenging.

### Comparative Example 1

### Back Side UV exposure

When the dicing film layer was subjected to UV exposure in the condition that the ring frame region near the attach layer was not exposed to the atmosphere so as not to be exposed to oxygen in the atmosphere or an oxygen atmosphere, the ring frame region did not retain the initial adhesive strength, unlike Example 1.

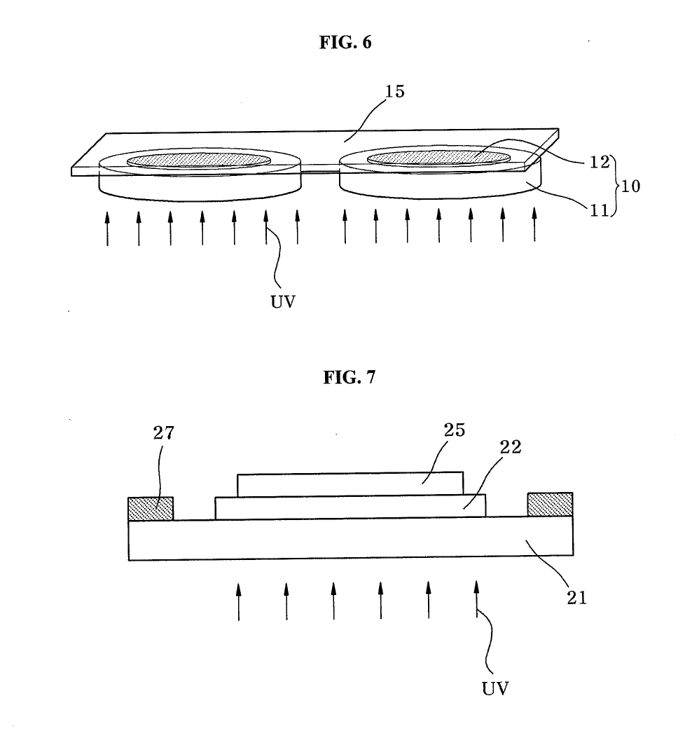

FIG. 6 illustrates a Comparative Example provided to explain the embodiments. Referring to FIG. 6, in a die-attach film 10 for a die-attach process, upper surfaces of a dicing film layer 11 and an attach layer 12 were all shielded by a cover layer 15, such that an upper surface of a rim of the dicing film layer 11 was not exposed to the atmosphere. In this case, when UV light was irradiated to the back side of the dicing film layer, the dicing film layer 11 underwent an overall reduction in adhesive strength. This was attributed to the fact that selective curing delay or obstruction by oxygen scavenger was not induced.

### Comparative Example 2

### UV Exposure Before Pick-Up after Sawing

FIG. 7 illustrates another Comparative Example provided to explain the embodiments. Referring to FIG. 7, UV exposure was carried out immediately before pick-up and after sawing. In this case, a separate masking blade (not illustrated) was employed to allow UV light to be irradiated only to an interface between a dicing film layer 21 and an attach layer 22 to induce a reduction in adhesive strength at the interface. UV exposure was performed immediately before pick-up. Thus, sawed wafers 25 were still attached to the attach layer 22. The masking blade may be provided to block the UV light from entering a ring frame 27. For example, this procedure was the same as the conventional sawing and pick-up processes. When the dicing film layer 21 was subjected to UV exposure and the ring frame region near the attach layer was not exposed to oxygen in the atmosphere or an oxygen atmosphere, the ring frame region did not retain the initial adhesive strength of the die-attach film, unlike Example 1.

Material properties of the die-attach films of Example 1 and Comparative Examples 1 and 2 were evaluated.

Measurement of Peel Strength of Dicing Film Layer

To test the material properties of the adhesive film layers prepared according to Example 1 and Comparative Examples 1 and 2, a photocurable adhesive composition was applied to a PET film and dried to form a coated film having a thickness of 8 to 12 μm. Then, the coated film was transferred to a polyolefin film and aged at 25 to 60° C. for 3 to 7 days and the adhesive strength and peel strength of the coated film layer measured

The measurement of the adhesive strength was conducted based on Section 3 of Korean Industrial Standards, KS-A-01107 (Test method of adhesive tape and adhesive sheet). Each of samples of die-attach films including the coated adhesive film layer and having a width of 25 mm and a length of 250 mm was adhered to a stainless steel plate (SUS) to form specimens as shown in Example 1 and Comparative Examples 1 and 2. With an adhesive tape adhered to a surface of the film layer, the sample was pressed once at a speed of 300 mm/min using a pressing roller at a load of 2 Kg to fabricate a test piece. 30 minutes after the sample was pressed, a folded portion of the test piece was flipped over (rotated 180°), and 25 mm of the test piece was peeled. Thereafter, the test piece was fixed to a clip over a tension tester, and the die-attach film was fixed to a clip under the tension tester, followed by drawing and peeling at a loading speed of 300 mm/min. The load of the tension tester was measured.

An Instron Series IX/s Automated Materials Tester-3343 was used as the tension tester. The adhesive strength was measured before and after UV exposure at a luminous intensity of 30 to 200 mJ/cm² using a high-pressure mercury lamp. The results are given in Table 1.

Measurement of Tackiness of Dicing Film Layer

The tackiness of the dicing film layer was measured using the test pieces, as prepared in Example 1 and Comparative Examples 1 and 2, and a probe tack tester (Tacktoc-2000). In the measurement method, the tackiness was defined as the maximum force required when the clean tip of a probe was brought into contact with the adhesive composition of the dicing film layer at a speed of 10+0.1 mm/sec and at a contact load of 9.79+1.01 kPa for 1.0+0.01 seconds based on ASTM D2979-71, and then separated therefrom.

Pick-Up Success Rate

The pick-up success rate was measured by testing the sawing process and the pick-up process using the die-attach films as prepared in Example 1 and Comparative Examples 1 and 2. The results are given in Table 1.

TABLE 1

| | Test result of material properties | | |
|---|---|---|---|
| | | Comparative | Comparative |
| | Example 1 | Example 1 | Example 2 |
| Peel strength before | 1.188 | 1.184 | 1.187 |
| photocuring | | | |
| Adhesive layer & attach layer | | | |
| (N/25 mm) | | | |
| Peel strength after | 0.0981 | 0.0995 | 0.1012 |
| photocuring | | | |
| Adhesive layer & attach layer | | | |
| (N/25 mm) | | | |
| Peel strength before | 1.068 | 1.054 | 1.055 |
| photocuring | | | |
| Adhesive layer & SUS | | | |
| (N/25 mm) | | | |
| Peel strength after | 0.7125 | 0.0895 | 0.543 |
| photocuring | | | |
| Adhesive layer & SUS | | | |
| (N/25 mm) | | | |
| Tackiness (before UV) | 112 | 98 | 124 |
| Attach layer adhered part | | | |
| Tackiness (after UV) | 13 | 15 | 18 |
| Attach layer adhered part | | | |
| Tackiness (before UV) | 112 | 98 | 124 |
| Other parts except for attach | | | |
| layer adhered part | | | |
| Tackiness (after UV) | 73 | 14 | 59 |
| Other parts except for attach | | | |
| layer adhered part | | | |
| Pick-Up success rate (%) | 100 | 0 (Evaluation | 96 |
| | | impossible) | |
| Ring frame separation | No | Separation | Separation |
| | separation | | |

In Table 1, it may be seen that the dicing film layer (the adhesive layer) of Example 1 exhibited substantially the same adhesive properties as Comparative Examples 1 and 2. In the attach layer adhered part of the dicing film layer (the comparatively reduced adhesive strength region 113 in FIG. 5), these Examples exhibited substantially the same material properties after photocuring. In other parts of the dicing film layer to which the ring frame was adhered, e.g., the ring frame region (114 in FIG. 5), Example 1 and Comparative Example 2 exhibited a predetermined level of tackiness or more, e.g., 70 or more, whereas Comparative Example 1 substantially lost the tackiness, thereby causing separation of the ring frame therefrom. In the die-attach film of Example 1, the ring frame region retained 60% or more of the initial tackiness of the die-attach film after UV exposure and the attach layer region was reduced in tackiness to 20% or less of the initial tackiness. As a result, embodiments may provide a die-attach film exhibiting both a high pick-up success rate and high ring frame-adhering strength after photocuring.

Thus, the embodiments provide a die-attach film and a method of manufacturing the same. The die-attach film may retain adhesive strength of the rim of the dicing film layer thereof to which the ring frame will be adhered, while lowering or reducing adhesion between the attach layer and the dicing film layer to provide peel strength for chip pick-up, thereby enabling elimination of UV exposure for lowering the adhesion during or between sawing and pick up processes. Accordingly, the die-attach film may enhance productivity of the overall die-attach process or the manufacturing process of a semiconductor package through elimination of the UV exposure performed to reduce adhesive strength between the sawing process and the pick-up process. Further, the die-attach film according to the embodiments may prevent pick-up failure by elimination of the UV exposure operation during semiconductor packaging, thereby improving reliability of the semiconductor packaging process.

By way of summation and review, the UV exposure performed immediately before pick-up may consume excessive amounts of time in the semiconductor packaging process and may significantly affect productivity of the semiconductor package, severely limiting improvements in productivity. Further, if a UV irradiator malfunctions during UV exposure, some of the wafers in a lot may not be subjected to UV exposure and may suffer pick-up failure. Accordingly, the sawed semiconductor chips may not be separated from the dicing film layer of the die-attach film during the pick-up process.

Accordingly, the embodiments provide a die-attach film that is configured to eliminate UV exposure between the sawing process and the pick-up process. For example, the embodiments provide a dicing film or die-attach film having both retention force (for retaining or holding the wafer during the dicing operation) and peel strength (for the pick-up process) through adjustment of tackiness of the dicing film layer, that is, adhesive strength of the dicing film layer, during manufacture of the die-attach film. Even though the adhesive strength of the dicing film layer is lowered in advance, undesirable separation of a ring frame from a rim of the dicing film layer during the dicing process may be avoided.

For example, in an embodiment, the rim of the dicing film layer and the ring frame may be adhered to each other with a considerably high binding force during the dicing and pick-up processes. Even though the tackiness of the dicing film layer may be significantly lowered, weakening of the binding force or adhering force of the dicing film layer to the ring frame may be avoided, thereby preventing undesirable separation of the ring frame from the dicing film layer during such processes. Avoiding separation of the ring frame may prevent damage of the wafer or the sawed chips inside the ring frame and damage of process equipment used for the dicing and pick-up processes. Thus, the embodiments may provide a die attach film that does not require UV exposure during a pick-up process.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of manufacturing a die-attach film including an attach layer for attaching to a wafer, the method comprising:
providing a dicing film layer with the attach layer thereon, the dicing film layer being prepared from a photocurable adhesive composition and including:
an attach layer region overlapping the attach layer such that the attach layer blocks inflow of oxygen into the attach layer region, and
a ring frame region, the ring frame region having an upper surface that is adjacent to the attach layer and is exposed to air or an oxygen atmosphere such that oxygen flows into the ring frame region; and
irradiating UV light to a back side of the dicing film layer to induce photocuring of the attach layer region, the oxygen in the ring frame region acting as a radical scavenger and suppressing photocuring of the ring frame region.

2. The method as claimed in claim 1, further comprising:
adhering a cover layer to the attach layer;
adhering a transparent handling film to the back side of the dicing film layer; and
removing the cover layer to expose the upper surface of the ring frame region to the air or oxygen atmosphere and induce inflow of oxygen into the upper surface of the ring frame region of the dicing film.

3. The method as claimed in claim 1, further comprising providing a light masking blade to the back side of the dicing film layer to shield the ring frame region from UV irradiation.

4. A die-attach film manufactured by the method as claimed in claim 1.

5. A die-attach film, comprising:
an attach layer for attaching to a wafer; and
a dicing film layer under the attach layer, the dicing film layer being prepared from a photocurable adhesive composition and including:
an attach layer region, and
a ring frame region,
wherein:
the attach layer region overlaps the attach layer and has a reduced tackiness through photocuring relative to the ring frame region, and
the ring frame region has an exposed upper surface adjacent to the attach layer and retains a higher tackiness than the attach layer region by avoiding the photocuring.

6. The die-attach film as claimed in claim 5, wherein the ring frame region retains about 60% or more of an initial tackiness of the dicing film layer and the attach layer region is reduced in tackiness to about 20% or less of the initial tackiness of the dicing film layer.

7. A die-attach film, comprising,
an attach layer for attaching to a wafer;
a dicing film layer under the attach layer, the dicing film layer being prepared from a photocurable adhesive composition and including an exposed ring frame region for attaching to a ring frame;
a cover layer adhered to the attach layer; and
a transparent handling film adhered to a back side of the dicing film layer, the transparent handling film being capable of transmitting UV light irradiated for partial photocuring of the dicing film layer.

8. The die-attach film as claimed in claim 7, wherein the ring frame region of the dicing film layer retains higher tackiness relative to a region of the dicing film layer overlapping the attach layer upon UV exposure.

9. The die-attach film as claimed in claim 7, wherein the cover layer includes a polyethylene terephthalate (PET) film layer.

10. The die-attach film as claimed in claim 7, wherein the dicing film layer is prepared from a photocurable adhesive composition cured by UV light.

11. The die-attach film as claimed in claim 10, wherein the photocurable adhesive composition includes an acrylic adhesive binder, a photo-initiator, and a thermal curing agent.

12. The die-attach film as claimed in claim 7, wherein the handling film includes a polyethylene terephthalate (PET) film, the PET film exhibiting a transmittance of at least about 80% with respect to the UV light.
